(19) United States
(12) Patent Application Publication
(10) Pub. No.: US 2015/0047239 A1
(43) Pub. Date: Feb. 19, 2015

(54) APPARATUS FOR SOCIAL NETWORKING IN OUTDOOR ENVIRONMENTS

(71) Applicant: Alan Ray Scott, Marietta, GA (US)

(72) Inventor: Alan Ray Scott, Marietta, GA (US)

(21) Appl. No.: 14/460,807

(22) Filed: Aug. 15, 2014

Related U.S. Application Data
(60) Provisional application No. 61/866,109, filed on Aug. 15, 2013.

(51) Int. Cl. G09F 15/02; G09F 7/02; G09F 7/00; G09F 15/00; G09F 17/00

(52) U.S. Cl. CPC G09F 15/02; G09F 15/0075; G09F 17/00; G09F 7/002; G09F 7/02
USPC 40/607.04; 40/607.05

(57) ABSTRACT

A flexible display member displays variable attributes of a user when the user is outdoors, such as at the beach or camping. The flexible display member is coupled to elongate grounding members that each having a bottom end for inserting into the ground (for example, with a corkscrew shape). The mounting members guide the user to mount the display member at the appropriate height to remain standing in the outdoor environment, and may convert the display member into a flag in some applications.

### CROSS REFERENCE TO RELATED APPLICATIONS

This application claims priority to provisional application No. 61/866,109, filed on Aug. 15, 2013, which is hereby incorporated by reference in its entirety.

### FIELD OF THE INVENTION

The embodiments relate generally to apparatuses and methods for physically displaying personal attributes, and, more specifically, to apparatuses for social networking in outdoor environments.

### BACKGROUND OF THE INVENTION

People often partake in outdoor activities, such as camping or beach trips, where they are in the vicinity of many other individuals that they do not know. At the beach, for example, thousands of strangers may pass an individual or family without any communication whatsoever. In contrast to an online environment, where people are notified of recommended friends and others with whom they have things in common, no such mechanism exists in public places where many strangers are present together.

At most, people might wear name tags, but this often does not provide enough information to be useful in a social networking context. Similarly, T-shirts and clothing may provide some inferential information about the wearer, but typically are not recognized as inviting conversation with strangers and, regardless, usually do not provide enough information to spark such conversations.

Consequently, a need exists for apparatuses and methods for social networking in outdoor environments.

### SUMMARY OF THE INVENTION

Embodiments described herein include apparatuses and methods for social networking in outdoor environments. In one embodiment the apparatus comprises a flexible display member made of a material that can non-destructively roll up. For example, it could be made of cotton or a synthetic fabric, such as those used for tarps, flags, or silt fences. The display member has a first side, second side, a top, a bottom, and a face that includes a plurality of attribute zones. In one embodiment, each attribute zone having at least one attachment member.

The display member is grounded by first and second elongate grounding members. Each of these may include a bottom end with a corkscrew shape that can twist into the ground. The corkscrew may be sized such that fully inserting it into the ground results in mounting the display member at an ideal height, for example, with the bottom between 5 and 10 inches off the ground. The bottom end may include one or more indicators of how deep the ends should be inserted into the ground. One example indicator is a protrusion (e.g., a lip, shelf, etc.) that prevents the respective elongate grounding member from being inserted further into the ground.

A plurality of attachable attribute items mate with the attachment members of the display member. These attribute items may provide information in the attribute zones of the display member. The attribute items may be selected by a user to represent aspects and attributes of that user, such as where the user lives, where they are from, their relationship status (e.g., married, single, complicated, in a relationship, etc.), their likes (e.g., particular sports, teams, or hobbies), their status or mood (e.g., exhausted, excited, interested), and other attributes.

In one embodiment, the attribute items include a clear sealable pocket that can accept a piece of paper with writing on it such that the writing is viewable and weatherproofed when the sealable pocket is closed. For example, this pocket may be snapped into place on in the attribute zone for the user's name, and the user may write their name and slide it into the pocket.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is an exemplary illustration of an apparatus for social networking, in accordance with an embodiment.

FIG. 2 is an exemplary illustration of an elongate grounding member coupled to the flexible display member, in accordance with an embodiment.

FIG. 3 is an exemplary illustration of an apparatus that includes top and bottom support members, in accordance with an embodiment.

Several example photographs of one embodiment of the apparatus are also included.

### DESCRIPTION OF THE EMBODIMENTS

Reference will now be made in detail to the present embodiment(s) (exemplary embodiments) of the invention, an example(s) of which is (are) illustrated in the accompanying drawings. Wherever possible, the same reference numbers will be used throughout the drawings to refer to the same or like parts.

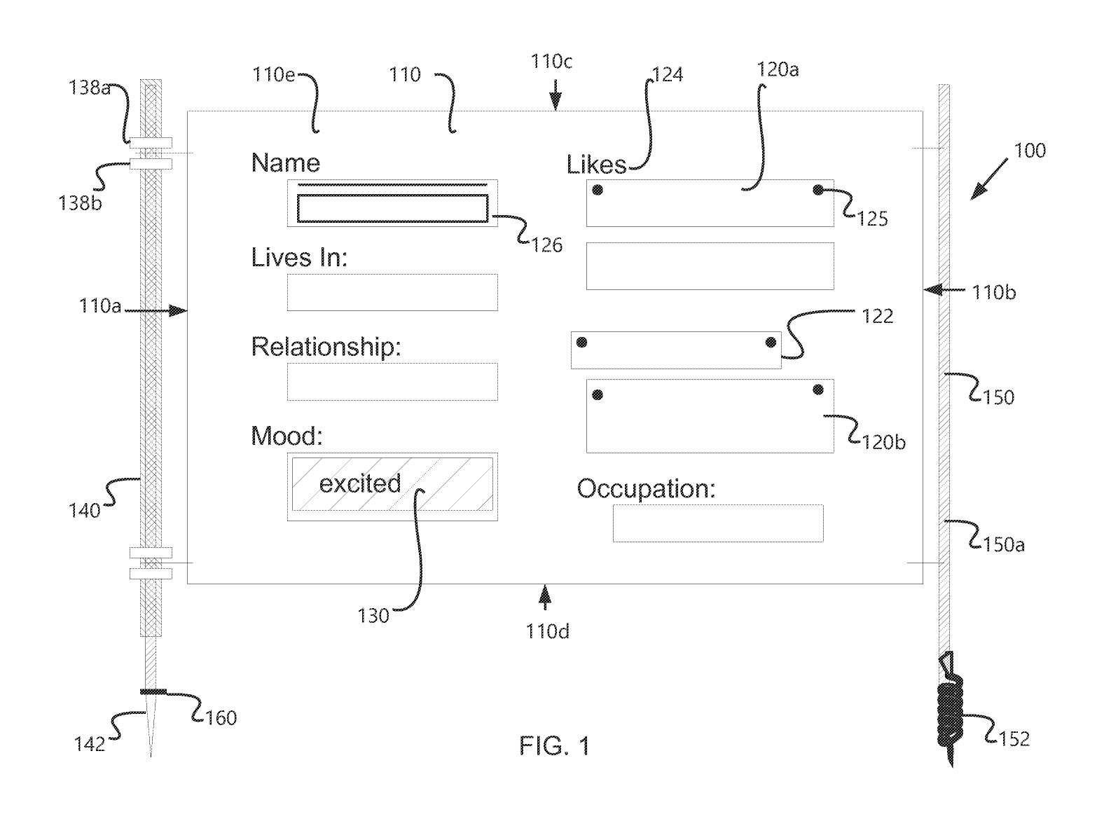

As shown by way of example in FIG. 1 and the attached photographs, the apparatus 100 for social networking may include a flexible display member 110 made of a material that can non-destructively roll up, the display member having a first side 110a, second side 110b, a top 110c, and a bottom 110d. The face 100e of the display member 110 includes a plurality of attribute zones 120a and 120b, where attributes of the user (e.g., likes, from, name, etc.) may be displayed. These attribute zones 120a and 120b have at least one attachment member 125 that allows for attachment of attribute items 130. For example, the attachment member 125 could be a snap (e.g., as illustrated), button, Velcro, magnets, a surface for mating with a removable adhesive, or other such structure(s).

The apparatus 100 also includes elongate grounding members 140 and 150 to hold it in place. The grounding members 140 and 150 each have a bottom pointed end 142 and 152 for mounting into the ground, which can include a spike 142 or a corkscrew 152 shape. The apparatus 100 may effectively transform from a sign to a flag tethered to one elongate grounding member in one embodiment.

### Display Member

The display member 110 may be comprised of various materials, including cotton or synthetic materials. The material may be wind resistant, such as by containing perforations or holes large enough in the weave to reduce the overall force of wind on the display member. The display member 110 may also be weather resistant, such that it can withstand rain, a salty ocean breeze, and other common outdoor occurrences.

The display member 110 is further flexible enough to roll up, in one embodiment. For example, it might be configured to roll up around one or more grounding members 140 and 150 for compact transport. In one embodiment, the display member 110 may roll up inside elongate grounding member 140, which may have a longitudinal slot through which the display member is input or output and a crank at the top to reel the display member 110 into and/or out of the elongate grounding member 140.

The display member 110 may have a width, for example, between 1 and 8 feet. In one embodiment, the display member is 5 feet wide. Example heights of the display member 110 include between 1 and 4 feet.

### Elongate Grounding Member

The second elongate member 150 may be different than the first elongate member 140 in one embodiment. For example, the first elongate grounding member 140 may be longer and the second elongate grounding member may be detachable, such that the apparatus converts into a flag. This may occur, for example, by telescoping the first elongate member 140 upward, which may be done while it is still grounded. For example, it may be unlocked for telescoping by removing or loosening a pin in one embodiment, or by twisting a portion of the first elongate grounding member.

Each elongate grounding members 140 and 150 may assemble from a plurality of pieces in one embodiment. For example, after the bottom piece 152 is mounted in the earth, a second longer piece 150a may fit into an opening in the bottom piece 152, such as by rotating the longer piece 150a into a threaded opening in the bottom piece 152 and/or snapping the longer piece 150a into place.

Each elongate grounding member 140 and 150 may also include an indicator 160 of how deep to insert the grounding member into the earth. For example, it could be a written indicator (not shown in FIG. 1), including different indicators for different environments (e.g., a first level for the beach, a second level for high wind, and a third level a wooded camp site). It could also be a physical indicator 160 that prevents the elongate grounding member 140 from moving further into the earth. In one embodiment, the indicator 160 is positioned such that the bottom 110d of the display member 110 is 5 to 10 inches off the ground. A first indicator may be for the beach and correspond to a 5 inch height of the bottom 110d. A second indicator may be for camping, and correspond to 12 inches, to elevate above ground debris and what is typically less wind with solid ground at camp sites.

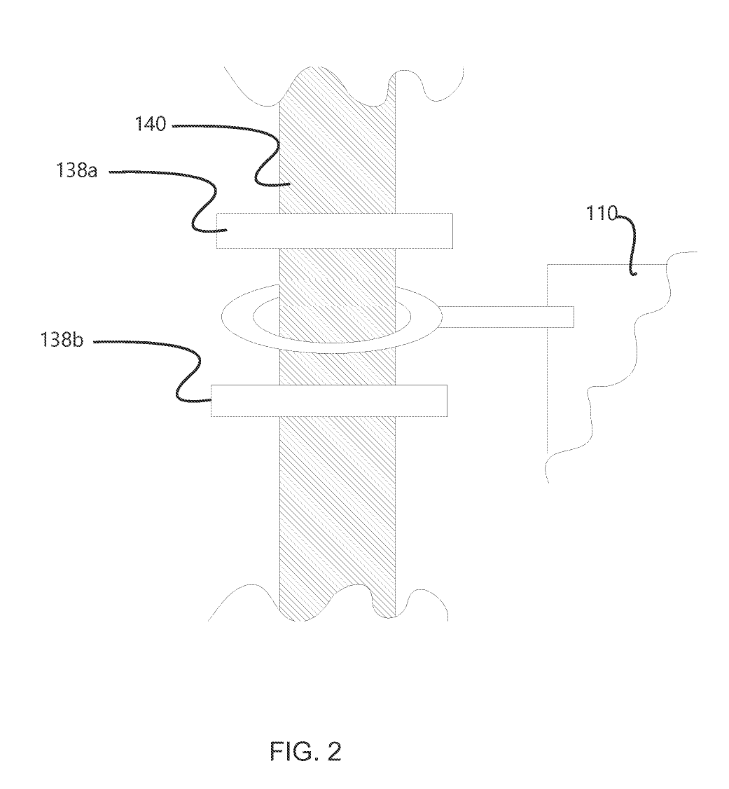

In one embodiment, an elongate grounding member 140 may rotably (i.e., slidably) couple to the display member 110, to allow the elongate grounding member 140 to be twisted into the earth while already attached to the display member 110. This may be accomplished while maintaining structural integrity of the apparatus 100 by providing a first pair of protrusions 138a and 138b, between which a side 110a of the display member 110 slidably couples between the first pair of protrusions, allowing first elongate grounding member 140 to rotate while remaining slidably coupled. An example is illustrated more closely in FIG. 2.

### Top and Bottom Members

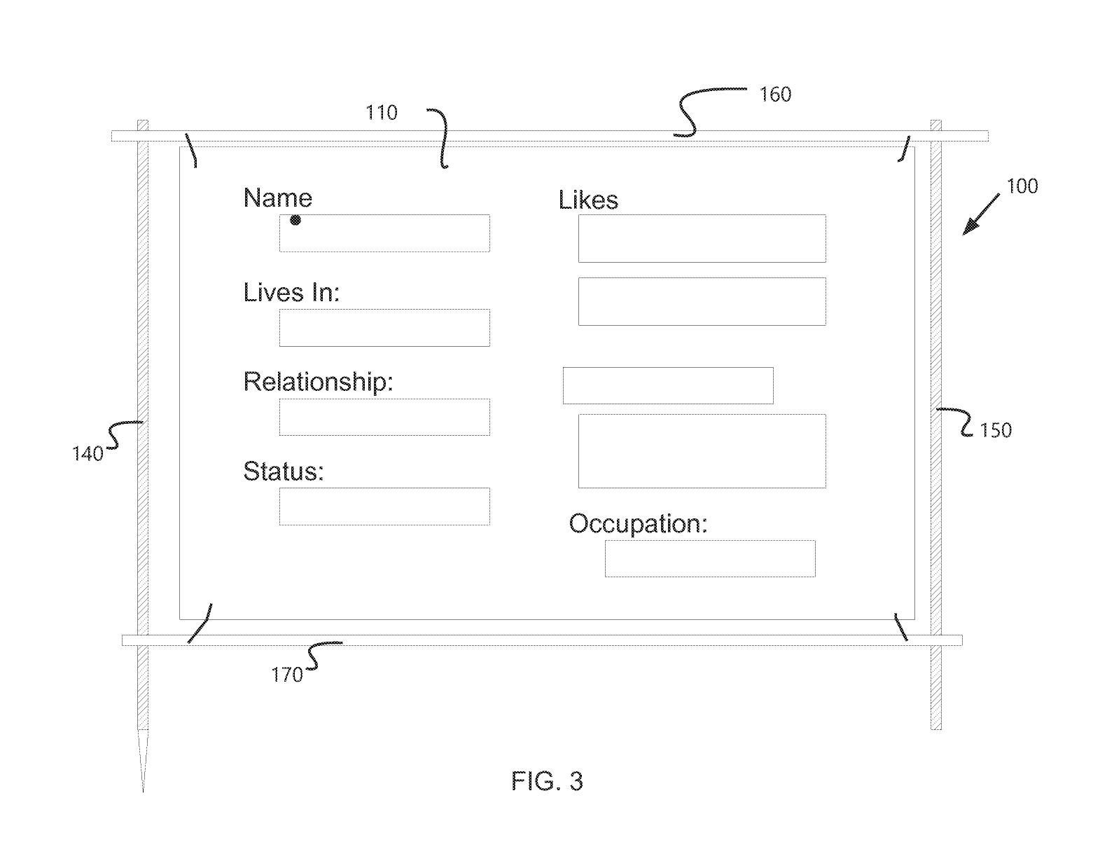

Turning to FIG. 3, in one embodiment, top and bottom support members 160 and 170 are also included and used in coupling the display member 110 to the elongate grounding members 140 and 150. For example, the top and bottom of the display member 110 may be coupled to the top and bottom support members 160 and 170, respectively. The top and bottom support members 160 and 170 are then connected by the user to the elongate grounding members 140 and 150 after the grounding members are inserted into the ground. For example, a user may twist the corkscrews of the elongate grounding members into the earth prior to connecting the grounding members to the top and bottom members. This may provide ease of installation and also allow for a range of distances between the first and second elongate support members while still keeping the display member adequately supported and viewable.

In one embodiment, this allows a user to insert the first 140 and second 150 grounding members into the earth, such that they are between 1 and 5 feet apart, while still being attachable to the same top 160 and bottom 170 support members to support the display member. For example, with regard to FIG. 3, the elongate grounding member 140 may be attached towards the end of top support member 160, as shown, or may be attached towards the middle of top support member 160 (not shown). By making the top and bottom support members 160 and 170 rigid, the display member 110 may be supported regardless of the location of the elongate grounding members 140 and 150 along the longitudinal span of the top and bottom support members 160 and 170.

In one embodiment, the elongate grounding members 140 and 150 attach to the top and bottom support members 160 and 170 via clamps fixed on the elongate grounding members 140 and 150. Other means of attachment are also possible.

In still another embodiment, the top member 160 may be used without the bottom member 170. The display member 110 may be converted into a flag that is attached to the top member 160. In one example, this is accomplished by telescoping the first elongate member 140 upward while the top member 160 is attached to the first elongate member. The flag may then hang freely and be readable even when there is no sufficient wind to blow the flag.

### Attribute Zones, Attribute Items, and Attachment Members

Returning to FIG. 1, the flexible display member 110 includes a plurality of attribute zones 120a and 120b, which may act as predefined locations for attaching attribute items 130. The attribute zones 120a and 120b may be outlined in one embodiment. The attribute zones 120a and 120b also may be next to description zones 124, which can include permanent labels, such as name, occupation, from, age, likes, mood, etc. in one embodiment. In another embodiment, at least one of the labels 122 is variable, such that a different label may be attached or otherwise supplied next to the corresponding attribute zone 120b. This may allow the user to select custom categories of information to display.

In one aspect, at least one attribute zone contains a permanent advertisement. For example, the “likes” zone 120a may contain an advertisement for the establishment where the apparatus was purchased, such that the advertisement is visible until it is covered by an attribute item selected by the user.

The attribute zones also each include at least one attaching member 125. For example, the attachment member could be a snap, button, Velcro, magnets, a surface for mating with a removable adhesive, or other such structure(s).

In another embodiment, the attachment member includes a built-in pocket with a transparent window 126 that allows the user to put custom attribute items into the pockets for display. Alternatively, in still another implementation, the attribute item includes the built-in pocket with a transparent window, and can be attached to the attribute zone via the attachment member (e.g., snaps).

Common attributes may be supplied as stock attribute items to select between when populating the display member. Additionally or in the alternative, users may purchase custom attribute items to place in the attribute zones. For example, a website may receive custom text and print or stitch the appropriate text onto an attribute item, which is then sent to the user for display on the display member.

Attribute items not being displayed may be collected in a pocket on the back side of the display member in one embodiment. Thus, if the user's mood changes, they can simply select a new mood from the pocket and attach it to the appropriate attribute zone.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for social networking, the apparatus comprising:
a flexible display member made of a material that can non-destructively roll up, the display member having a first side, second side, a top, a bottom, and a face that includes a plurality of attribute zones, each attribute zone having at least one attachment member;
first and second elongate grounding members each having a bottom end with a corkscrew shape, the first and second elongate grounding members supporting the display member; and
a plurality of attachable attribute items that mate with the attachment members, the plurality of attribute items each directed to a characteristic of a person whose name is displayed on the display member.

2. The apparatus of claim 1, wherein the second elongate grounding member detaches and the first elongate grounding member telescopes upward, turning the flexible display member into a flag.

3. The apparatus of claim 1, wherein the first elongate grounding member is longer than the second elongate grounding member and also has a longer corkscrew shape than the second elongate grounding member.

4. The apparatus of claim 1, further comprising a top support member and a bottom support member, wherein the top and bottom support members each attach to the first and second elongate grounding member, the top and bottom support members being attachable even when the distance between the first and second elongate grounding members varies.

5. The apparatus of claim 4, further comprising a top support member and a bottom support member, wherein the top and bottom support members each attach to the first and second elongate grounding member, the top and bottom support members being attachable even when the distance between the first and second elongate grounding members varies.

6. The apparatus of claim 1, wherein multiple of the attachment members are snaps.

7. The apparatus of claim 1, wherein at least one of the attachable attribute items includes a clear sealable pocket that can accept a piece of paper with writing on it such that the writing is viewable and weatherproofed when the sealable pocket is closed.

8. The apparatus of claim 1, wherein one of the attribute zones contains an advertisement that is covered when one of the plurality of attachable attribute items is mated to the attribute zone via the attachment member.

9. The apparatus of claim 1, wherein the flexible display member contains text identifying the contents of each attribute zone.

10. The apparatus of claim 1, wherein the flexible display member further includes a plurality of description zones where descriptions of the attribute zones may be removeably attached.

11. The apparatus of claim 1, wherein at least one of the attachable attribute items includes a clear sealable pocket that can accept a piece of paper with writing on it such that the writing is viewable and weatherproofed when the sealable pocket is closed.

12. The apparatus of claim 1, wherein the first and second elongate grounding members each include an indicator of how deep the ends should be inserted into the ground.

13. The apparatus of claim 12, wherein each indicator includes a protrusion that prevents the respective elongate grounding members from being inserted further into the ground.

14. The apparatus of claim 1, wherein the first elongate grounding member includes a first pair of protrusions, between which the first side slidably couples between the first pair of protrusions, allowing first elongate grounding member to rotate while remaining slidably coupled.

15. The apparatus of claim 1, wherein the first and second elongate grounding members each include a triangular top grip.

16. The apparatus of claim 1, wherein the first and second elongate grounding members each include an indicator of how deep the ends should be inserted into the ground.

17. An apparatus for social networking, the apparatus comprising:
a display member made of a flexible material that can roll up, the display member having a first side, second side, a top, a bottom, and a face that includes a plurality of attribute zones, each attribute zone having at least one attachment member;
a first elongate grounding member having a bottom end with a point for pressing into ground to support the display member, wherein the display member slidably couples to the first elongate grounding member between a first pair of protrusions, allowing first elongate grounding member to rotate while remaining slidably coupled; and
a plurality of attachable attribute items that mate with the attachment members, the plurality of attribute items each directed to a characteristic of a person whose name is displayed on the display member.

18. The apparatus of claim 17, the apparatus further comprising:
a second elongate grounding member that may support an opposite side of the display member than the first elongate grounding member,
wherein the second elongate grounding member detaches from the display member and the first elongate grounding member telescopes upward to allow the display member to be displayed as a flag.

19. The apparatus of claim 17, wherein at least one of the attribute items is comprised of a sealable pocket that includes a clear viewing and window and that can accept a piece of paper with writing on it, such that the writing is viewable and weatherproofed when the sealable pocket is closed.

20. The apparatus of claim 17, wherein the first elongate grounding member includes a first indicator of a first depth to which that the first elongate grounding member needs to be grounded in beach sand, and a second indicator of a second and different depth to which that the first elongate grounding member needs to be grounded in dirt.
